(19) United States
(12) Patent Application Publication
(10) Pub. No.: US 2023/0319428 A1
(43) Pub. Date: Oct. 5, 2023

(54) CAMERA COMPRISING LENS ARRAY

(71) Applicant: Microsoft Technology Licensing, LLC, Redmond, WA (US)

(72) Inventors: Curtis Alan TESDAHL, Fort Collins, CO (US); James Peele TERRELL, JR., Bellvue, CO (US); David C ROHN, Fort Collins, CO (US)

(73) Assignee: Microsoft Technology Licensing, LLC, Redmond, WA (US)

(21) Appl. No.: 17/657,865

(22) Filed: Apr. 4, 2022

(51) Int. Cl. H04N 5/232; G06V 40/19; G06T 3/40; G06T 7/571; G06T 7/73

(52) U.S. Cl. CPC H04N 5/23232; G06V 40/19; G06T 3/4053; G06T 7/571; G06T 7/73; G06T 2207/20081

(57) ABSTRACT

Examples are disclosed herein that relate to eye imaging on a near-eye system using an eye-imaging camera that includes an array of lenses. One example provides a near-eye system, comprising an eye-imaging camera comprising an image sensor, and an array of lenses, each lens of the array of lenses configured to focus an image of an eye onto a different area of the image sensor than each other lens of the array of lenses.

### BACKGROUND

Eye-imaging cameras may be used in near-eye devices, such as smart glasses and other head-mounted devices, for such purposes as eye tracking, iris recognition and eye positioning. Eye tracking may be employed as a user input mode, while iris recognition may be used for user identification and authentication. Eye positioning may be used for display calibration, for example, to determine IPD (Interpupillary Distance). Eye-imaging cameras may utilize a refractive lens system comprising one or more lenses to focus an image of the eye on an image sensor. Due to the focal length of the lens system, an eye-imaging camera may be bulky, and thus difficult to place on some near-eye devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to performing eye imaging on a near-eye system using a camera comprising an array of lenses. One example provides a near-eye system comprising an eye-imaging camera. The eye-imaging camera comprises an image sensor and an array of lenses, each lens of the array of lenses configured to focus an image of an eye onto a different area of the image sensor than each other lens of the array of lenses.

### BRIEF DESCRIPTION OF THE DRAWINGS

FIG. 1 shows a user wearing an example near-eye device comprising an eye-imaging camera.

FIG. 2 shows the near-eye device of FIG. 1.

FIGS. 3A-3B schematically show a size of an example eye-imaging camera comprising a traditional lens system compared to a size of an example eye-imaging camera comprising a lens array.

FIG. 4 shows a block diagram illustrating an example eye-imaging camera.

FIGS. 5A and 5B schematically show a top view and a side view of an example lens array comprising metamaterial lenses.

FIG. 6 shows an example metamaterial lens array comprising four lenses configured to image a field of view from offset perspectives.

FIG. 7 shows an example eye-imaging camera that includes a lens array configured to steer a field-of-view of an image sensor away from a direction normal to a plane of a lens array.

FIG. 8 schematically shows an example eye-imaging camera comprising a lens array configured to provide an extended depth of field.

FIG. 9 shows a flow diagram depicting an example method of imaging an eye on a near-eye device.

FIG. 10 shows a block diagram of an example computing system.

### DETAILED DESCRIPTION

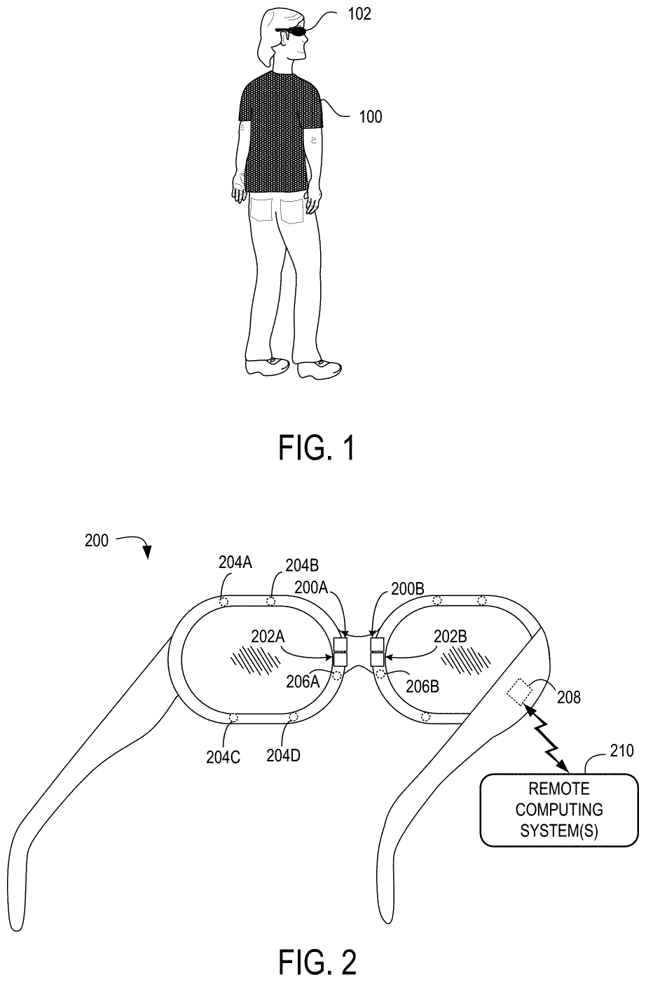

As mentioned above, near-eye devices, such as head-mounted display (HMD) devices, may comprise eye-imaging cameras for uses such as gaze tracking, eye positioning, and/or user identification/authentication via iris recognition. FIG. 1 illustrates a user 100 wearing an example near-eye device 102 in the form of eyeglasses comprising one or more eye-imaging cameras. The term “eye-imaging camera” is used herein to encompass eye tracking (gaze tracking) cameras, iris recognition cameras, and/or any other camera configured to image an eye of a user of a near-eye device. In some examples, near-eye device 102 may be configured as a display device to present augmented reality (e.g. mixed reality) and/or virtual reality imagery to a user. In other examples, near-eye device 102 may comprise eye-imaging cameras but no displays, for example to remotely control other devices by eye gesture inputs.

An eye-imaging camera in a near-eye device may utilize one or more refractive lenses to focus an image of a user's eye on an image sensor. However, such a lens system may be bulky due to the focal length of the lens system. Further, the lens system may be positioned on the device in a location that is visible to a user wearing the device, such as on or adjacent to a nose bridge of the device. The size and placement of the lens system may result in the lens system being bothersome and/or aesthetically displeasing. One potential solution to reduce the bulkiness of an eye-imaging camera may be to utilize a plurality of smaller cameras arranged closely together. Images from the plurality of cameras may be combined via processing. However, a near-eye device comprising such an arrangement of separate cameras may be relatively challenging and expensive to manufacture.

Accordingly, examples are disclosed that relate to an eye-imaging camera that uses a lens array comprising multiple lenses each configured to focus an image of an eye on a different area of an image sensor. The resulting image formed on the image sensor comprises an array of sub-images. The lens array may allow for shorter focal lengths, and thereby provide for a reduced camera size, compared to eye-imaging cameras with traditional lens systems. The reduction in size may allow the eye-imaging camera to be integrated more easily into smaller near-eye devices, such as devices with an eyeglass form factor. In some examples, the lenses of the lens array may comprise metamaterial lenses and/or metasurface lenses. The term “metamaterial lens” is used hereinafter to refer both to metamaterial and metasurface lenses. Metamaterial lenses may have a thin, flat form factor that are more easily accommodated into smaller form factor devices. Further, metamaterial lenses provide tighter boresight tolerances as compared to an array of individual refractive lenses. They also allow steerable fields-of-view (FOVs), and can accommodate a wide range of possible optical powers.

In some examples, the lenses of the lens array may have generally parallel, but slightly different, boresights. The term “generally parallel” indicates parallelism within manufacturing tolerances. In one example, the lenses in the lens array are aligned within a tolerance, and the lenses of the lens array produce similar images. However, slight shifts allow higher frequency aliased sub-pixel information to be extracted from the multiple images. This allows recovering of some of the resolution loss as compared to a traditional single full lens.

In another example, the lens array breaks the FOV up into smaller individual FOVs that have at least some overlap. This keeps the effective resolution performance of an individual sub-lens close to a traditional single full lens. In such examples, the lenses each will focus a similar image onto different areas of the image sensor, from slightly different perspectives. The different perspectives provided by different lenses in a lens array may provide depth perspective of objects captured in two or more of the images due to the lateral separation of the lenses in the lens array. Further, the different perspectives may provide for and/or more secure authentication, as it may be more difficult to spoof an iris pattern from multiple perspectives than from a single perspective. Although described herein in the context of eye-imaging cameras, it will be understood that a camera with a lens array as disclosed also may be implemented in cameras for face-tracking, head-tracking, and/or other suitable uses. Further, while the disclosed examples utilize lens arrays having lenses with generally parallel boresights, in other examples lenses of a lens array may have different boresights. In such examples, the boresights are set to cover different FOVs, possibly with some overlap in FOV. This allows the resolution of the scene to be maintained across multiple sub-lenses of a lens array as compared to a single traditional lens that has the same FOV coverage.

FIG. 2 schematically shows near-eye device 102 in more detail. Near-eye device 102 includes eye-tracking cameras 200A, 200B and iris recognition cameras 202A, 202B, as examples of eye-imaging cameras. In other examples, a near-eye device may include one of, but not both of, an eye-tracking camera and iris recognition camera. Near-eye device 102 may include any other suitable components not shown, such as near-eye displays, outward-facing cameras, face-tracking cameras, head-tracking cameras, acoustic sensors, motions sensors, and other input and output devices. In some examples, a same camera may be used for iris imaging and gaze tracking. Further, in some examples, an eye-imaging camera may be used for other suitable purposes than iris recognition, gaze tracking or eye positioning.

Each eye-tracking cameras 200A, 200B is used to determine a gaze direction of an eye of a user. Each eye-tracking camera 200A, 200B comprises an image sensor and a lens array, examples of which are described in more detail below. Near-eye device 102 further comprises a plurality of glint light sources for each eye-tracking camera 200A, 200B. Four glint light sources are illustrated for eye tracking camera 200A at 204A, 204B, 204C, and 204D. Eye tracking camera 200B may have a similar arrangement of glint light sources. In other examples, other suitable numbers of glint light sources may be used. Each glint light source 204A-D is configured to direct light (e.g. infrared light) toward a cornea of an eye. Image data from each eye-tracking camera 200A, 200B is analyzed to determine the locations of reflections (“glints”) from glint light sources 204A-D and a location of the pupil of the eye. The reflection and pupil location data may then be used to determine a gaze direction, in combination with anatomical models related, for example, to eye geometry and/or head geometry. In the depicted example, the glint light source(s) 204A-D are posited to be above and below an eye of a user, and the eye-tracking cameras 200A, 200B are positioned at a nose bridge. In other examples, eye tracking cameras and glint light sources may be positioned in any other suitable locations on the near-eye device.

Each iris recognition camera 202A, 202B is used to capture an image of an iris of a user's eye, such as for identification and/or authentication purposes. In some examples, each iris recognition camera comprises an image sensor and a lens array. Near-eye device 102 further comprises one or more light sources (e.g. infrared light sources), illustrated schematically at 206A, 206B. Images of an iris may be processed and matched to previously stored iris data for a user to authenticate the user. In other examples, an iris recognition camera and/or light sources for illuminating an iris may be located at any other suitable location on a near-eye device. Further, as mentioned above, in some examples a same camera may be used for gaze tracking, iris imaging, and/or other suitable eye-imaging functions.

Near-eye device 102 further comprises a controller 208. Controller 208 comprises, among other components, a logic subsystem comprising a processor, and a storage subsystem comprising one or more storage devices. The storage subsystem stores instructions executable by the logic subsystem to control the various functions of near-eye device 102, examples of which are described in more detail below. Near-eye device 102 further may comprise a communication subsystem for communicating via a network with one or more remote computing system(s) 210. For example, image data acquired by one or more of cameras 200A, 200B, 202A and/or 202B may be sent to remote computing system(s) 210 for processing in some examples.

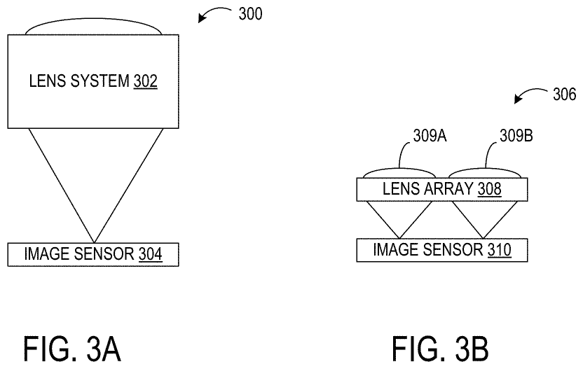

In the depicted example of FIG. 2, the eye-tracking cameras 200A, 200B and the iris imaging cameras 202A, 202B are located adjacent to a nose bridge of the near-eye device 102. As mentioned above, each camera 200A, 200B, 202A, 202B may utilize a lens array that provides for shorter focal lengths and a more compact form factor than traditional lens systems to help the eye-imaging cameras fit within the depicted form factor more readily. FIGS. 3A and 3B schematically show a comparison of a size of an eye-imaging camera comprising a traditional lens system compared to an eye-imaging camera comprising a lens array. A camera comprising a traditional lens system is shown in FIG. 3A at 302. Lens system 302 comprises one or more vertically stacked lenses, and forms a single image on image sensor 304. Lens system 302 has a relatively longer focal length that occupies relatively more space. Further, the physical size of lens system 302 is relatively less compact. In contrast, a camera comprising a lens array is shown in FIG. 3B at 306. In camera 306, each lens 309A, 309B of lens array 308 focuses a corresponding image onto a different area of image sensor 310. As described above, in some examples, lenses 309A, 309B may be aligned within a tolerance, and each lens may produce a similar image. However, the slight shifts in perspective between the images allow higher frequency aliased sub-pixel information to be extracted from each image, recovering some of the resolution loss as compared to a traditional single full lens. In other examples, lens array 308 may break the FOV up into smaller individual FOVs that slightly overlap, keeping the effective resolution performance of each individual lens 309A, 309B close to a traditional single full lens. Lenses 309A, 309B of lens array 308 may have shorter working focal lengths than lens system 302, and therefore may fit within more compact form factors. Likewise, lens array 308 may have a relatively more compact size than lens system 302, providing for additional space savings. In the depicted example, lens array may comprise a 2×2 array of lenses, two of which are visible in the side view of FIG. 3. Such a lens array forms a 2×2 array of sub-images on the image sensor. In other examples, lens array 308 may have any other suitable number of lenses.

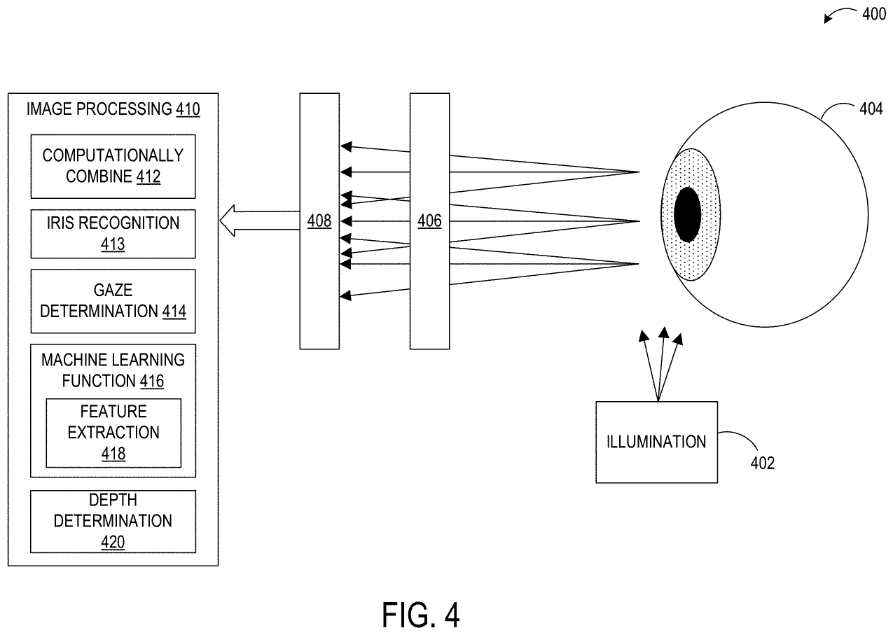

FIG. 4 shows a block diagram of an example eye-imaging camera system 400 including an illumination stage 402 configured to illuminate an eye 404, and a lens array 406 configured to focus a plurality of images of the eye 404 onto an image sensor 408. As mentioned above, where the boresights of lenses of the lens array 406 are aligned with one another, each lens in the lens array 406 may focus a near-identical image onto different areas of the image sensor 408. The different areas of the image sensor 408 may be at least partially overlapping, or may be fully separate in various examples.

The multiple images focused on the multiple different portions of the image sensor by the lens array 406 that are captured in each frame of image data may be processed in any suitable manner. Image processing is indicated schematically at 410. In some examples, a single output image may be desired. In such examples, the individual images may be computationally combined at 412 to form a single, combined image. The use of a plurality of different images of a same or similar FOV may allow the combined image to have a higher resolution than the individual images focused by each lens of the lens array. Any suitable image combining algorithms may be utilized. Examples include super resolution algorithms, which utilize multiple lower resolution images with slight shifts in the images to form a higher resolution image. In examples where an iris is being imaged for iris recognition 413, the image resulting from the computational combination of different images from the different portions of the image sensor may be compared to a stored iris image that was acquired and processed similarly. Likewise, the computationally combined image may be used to track gaze, as indicated at 414, using any suitable gaze tracking methods.

In other examples, the individual images captured on different portions of the image sensor may be individually processed. For example, with regard to gaze tracking, a gaze direction may be determined for each image focused by each lens of the lens array, and then the resulting plurality of gaze directions may be combined to produce a final gaze direction for output. Likewise, with regard to iris imaging, the multiple images of the iris from the lens array may be compared to corresponding multiple images of the iris stored in a user profile.

In further examples, the individual images captured on the different portions of the image sensor may be processed using machine learning methods. For example, a trained machine learning function 416 may be used to identify a gaze direction from the multiple images captured in a frame of image data. In some such examples, raw image data may be input into the machine learning function. In other examples, one or more feature extraction methods 418 may be used to extract features from the image data for analysis by machine learning. For example, locations of a pupil and of glint light reflections from a cornea may be extracted from the image data and input into the machine learning function 416. Any suitable machine learning function may be used. Examples include various neural network architectures, such as convolutional neural networks. Such a function may be trained using image data comprising images of eyes acquired using the lens array 406, and labeled with known gaze directions. The function may be trained to output a probable gaze direction based upon the different images of the eye and eye glints captured by each lens of the lens array. Any suitable training algorithms may be used. Examples include backpropagation algorithms (e.g. a gradient descent algorithm).

The different perspectives of an eye captured by each of the images further may provide depth information. This depth perspective may allow a number of glint light sources used for eye tracking to be reduced compared to the use of a traditional lens system (e.g. lens system 302), as a greater number of glint sources is sometimes used to obtain more depth perspective when performing gaze tracking. Further, additional gaze depth information from the offset images may allow the use of an LED glint if the glint is partially obstructed in one image of the array of images and not another. The different perspectives of the eye may result in fewer obstructed LEDs, and thus allow the use of relatively fewer LEDs for accurate gaze tracking.

Further yet, in other examples, the different perspectives of an eye captured by each of the images may allow the use of “glintless” gaze tracking methods that simplify an eye tracking assembly by eliminating a plurality of glint LEDs surrounding the eye. The number of LEDs may be reduced to a single LED that provides flood illumination, for example.

Additionally, in some examples, stereo imaging techniques may be used to perform depth determination using two or more different perspectives provided by the different images in a frame of image data, as indicted at 420. Such stereo imaging may be used to compute a position of an eye relative to a near-eye device for determining gaze directions. This may allow for more accurate gaze tracking than the use of an assumed eye position.

As mentioned above, the use of image data that includes multiple perspectives for performing iris recognition may help to avoid spoofing attacks. For example, spoofing is sometimes performed by imaging a printed version of an iris. Acquiring multiple images of the iris from different perspectives using a lens array in conjunction with an image sensor as disclosed herein may provide for stronger authentication, as a flat image of an iris may not have the same perspective dependence as a real iris.

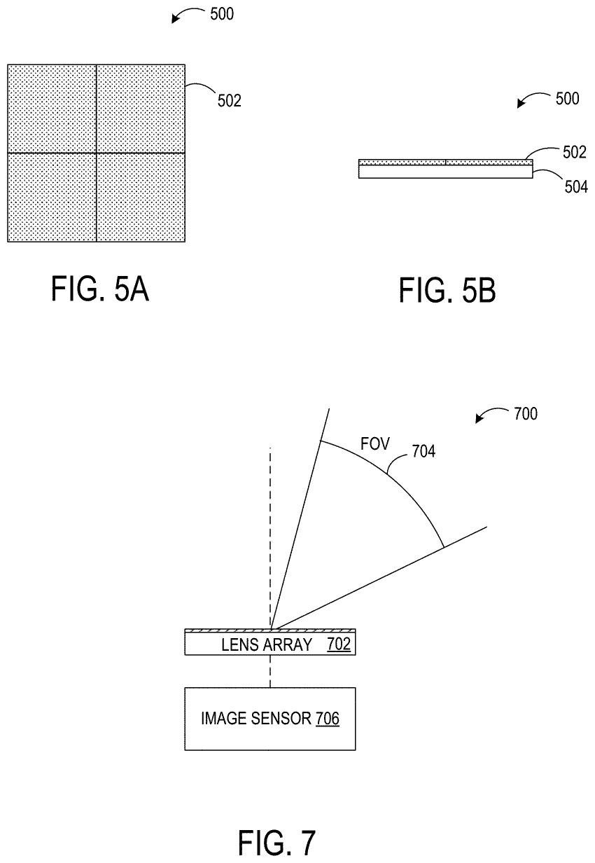

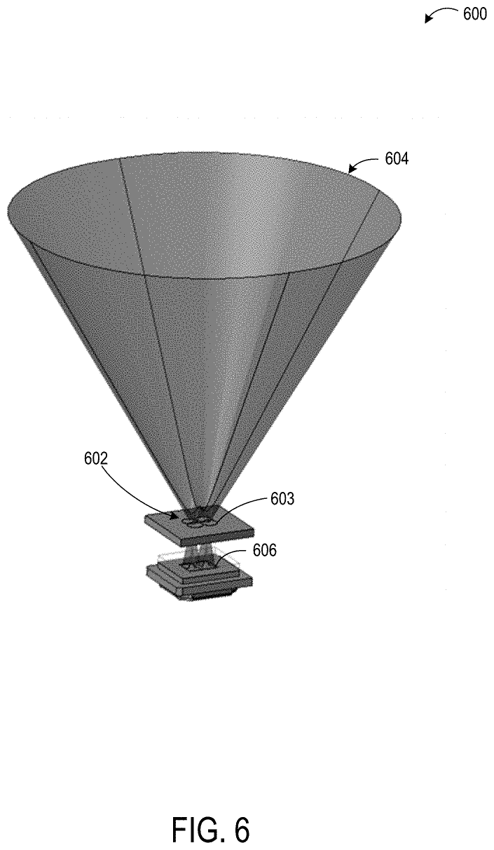

Any suitable type of lens may be used for each lens of a lens array as disclosed. In some examples, an array of lenses may comprise refractive lenses. In other examples, as mentioned above, an array of lenses may comprise metamaterial lenses. FIG. 5A shows an example array 500 of metamaterial lenses 502 arranged in a 2×2 array from a top view, and FIG. 5B shows a side view of the array of metamaterial lenses 502 formed on a substrate 504. Metamaterial lenses may have a lower profile than refractive lenses, and thus may fit more easily into smaller form factor near-eye devices. FIG. 6 schematically shows an example eye-imaging camera 600 that includes a metamaterial lens array 602 comprising four lenses, one of which is shown at 603. Each lens is configured to focus an image of a similar field of view 604 onto an image sensor 606, but from slightly offset perspectives due to the different locations of each lens of the lens array 602.

Metamaterials may be engineered to have variety of optical properties for use in a near-eye display system. As one example, metamaterial lenses may be designed to have a FOV with a center that is angularly offset from a normal of a plane of an image sensor. This may allow an array of metamaterial lenses to directly image an eye even when a camera comprising the array is posited obliquely to the eye. As a more specific example, an eye-imaging camera that is positioned on a nose bridge or frame of an eyeglass form factor may not capture sufficiently robust images of a user's eye for processing unless the camera is tilted to face the image sensor toward the eye. However, tilting the camera may also cause the camera to protrude at an angle toward a user's face. In contrast, an array of metamaterial lenses array may be engineered to steer a FOV of the image sensor in a desired direction, while maintaining a flat profile. FIG. 7 schematically shows an example eye-imaging camera 700 in which an array of metamaterial lenses 702 is configured to offset an FOV 704 of image sensor 706 from a direction normal to a plane of image sensor 706. Thus, the use of an array of metamaterial lenses may allow a camera to be placed and oriented in a manner that does not cause the camera to protrude at an angle, while still allowing imaging of a user's eyes.

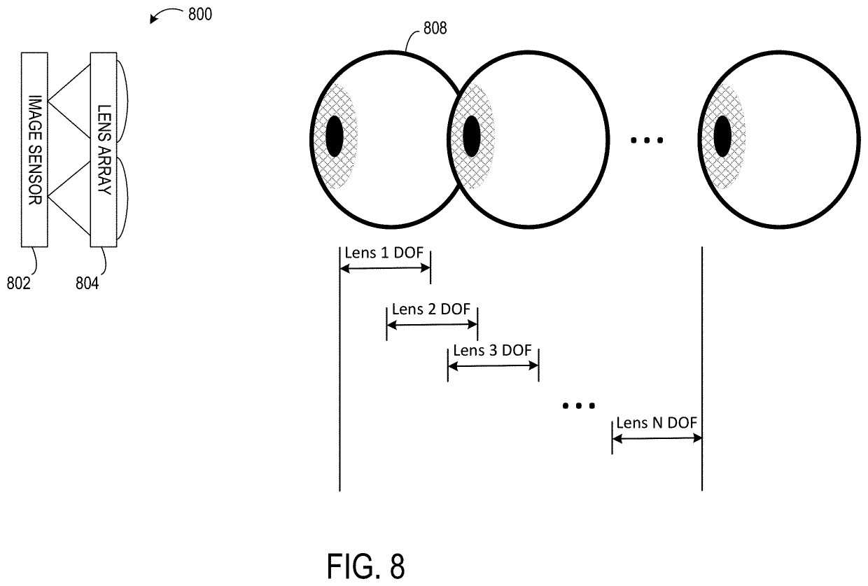

In some examples, each sub-lens within a lens array may comprise a different depth of field (DOF) range. FIG. 8 schematically shows an example eye-imaging camera 800 comprising an image sensor 802 and a lens array 804 having an arbitrary number N of lenses. Each lens of lens array 804 is configured to have a different DOF range to achieve an extended depth of field (EDOF). Lens array 804 may thereby help to maintain a focused image of an eye across a larger range of eye relief distances than where a single lens is used or where each lens of a lens array has a same DOF.

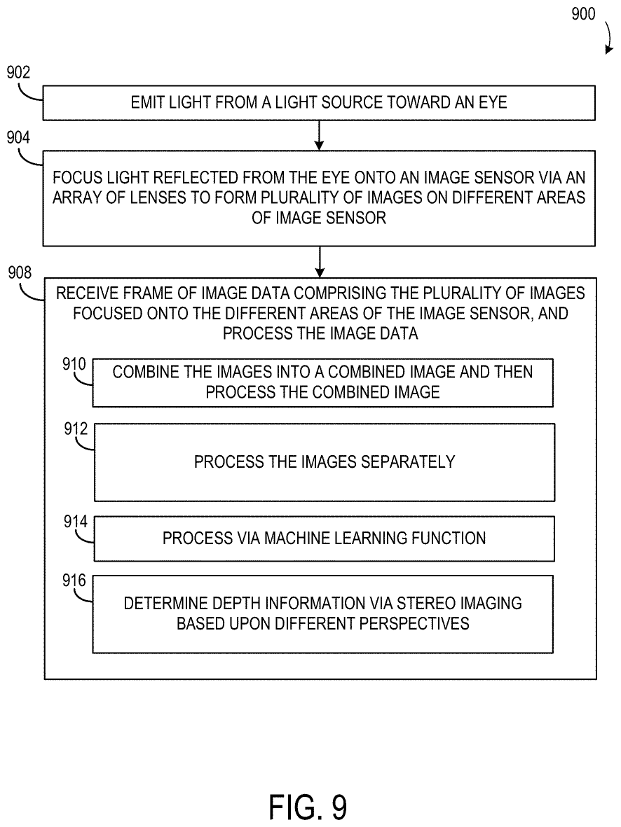

FIG. 9 shows an example method 900 of imaging an eye on a near-eye display system. Method 900 includes, at 902, emitting light from a light source toward an eye. In the case of an eye-imaging camera, the light may be emitted from glint light sources configured to produce reflections in images of the eye. In the case of an iris imaging camera, the light emitted may be configured to illuminate the iris to allow iris recognition to be performed.

Method 900 further includes, at 904, focusing light reflected form the eye onto an image sensor via an array of lenses, such that each lens focuses an image of the eye onto a different area of the image sensor than each other lens. This forms a plurality of images, each at a different location on the image sensor. As described above, in some examples, one or more lenses of the array of lenses may comprise a metamaterial lens. In other examples, one or more lenses of the array of lenses may comprise a refractive lens. In some examples, two or more of the different areas of the image sensor may be partially overlapping. In other examples, the different areas may be spatially separated.

Method 900 further includes, at 908, receiving, at a controller, a frame of image data comprising the plurality of images focused onto the different areas of the image sensor, and processing the image data. In some examples, the images may be combined into a combined image, at 910, using any suitable computational combination algorithms. The combined image then may be processed, for example to determine a gaze direction or perform iris recognition. In other examples, the images may be separately processed without being computationally combined, as indicated at 912. For example, a gaze direction may be determined for each image separately, and then the determined gaze directions may be computationally combined (e.g. by averaging) to determine a gaze direction for output. In further examples, as indicated at 914, the frame of image data comprising the plurality of images may be processed by a trained machine learning function. In some such examples, raw image data may be input into a machine learning function, such as a convolutional neural network. In other examples, features may be extracted from the images, and the features may be input into the machine learning function. The machine learning function may be trained to provide any suitable output. For example, a neural network may be trained to output a most likely gaze direction. Further, in some examples, processing the image data may comprise determining depth information based upon the different perspectives of the images in the frame of image data using stereo imaging methods, at 916.

Thus, by using an array of lenses each configured to focus an image of an eye onto a different area of the image sensor than other lenses of the array, an eye-imaging camera may have a smaller size compared to a camera using a traditional refractive lens system. This may allow the eye-imaging camera to be integrated more easily into a small form factor device, such as a device having an eyeglasses form factor.

In some embodiments, the methods and processes described herein may be tied to a computing system of one or more computing devices. In particular, such methods and processes may be implemented as a computer-application program or service, an application-programming interface (API), a library, and/or other computer-program product.

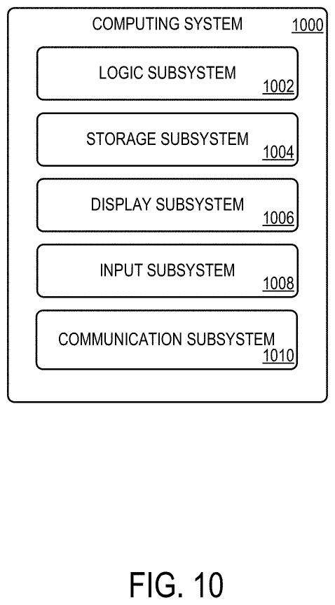

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), near-eye devices, and/or other computing devices. Computing system 1000 may represent near-eye device 102, remote computing system 210, and eye-imaging camera system 400, as examples.

Computing system 1000 includes a logic subsystem 1002 and a storage subsystem 1004. Computing system 1000 may optionally include a display subsystem 1006, input subsystem 1008, communication subsystem 1010, and/or other components not shown in FIG. 10.

Logic subsystem 1002 includes one or more physical devices configured to execute instructions. For example, logic subsystem 1002 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 1002 may include one or more processors configured to execute software instructions. Additionally or alternatively, logic subsystem 1002 may include one or more hardware or firmware logic machines configured to execute hardware or firmware instructions. Processors of logic subsystem 1002 may be single-core or multi-core, and the instructions executed thereon may be configured for sequential, parallel, and/or distributed processing. Individual components of logic subsystem 1002 optionally may be distributed among two or more separate devices, which may be remotely located and/or configured for coordinated processing. Aspects of logic subsystem 1002 may be virtualized and executed by remotely accessible, networked computing devices configured in a cloud-computing configuration.

Storage subsystem 1004 includes one or more physical devices configured to hold instructions executable by logic subsystem 1002 to implement the methods and processes described herein. When such methods and processes are implemented, the state of storage subsystem 1004 may be transformed—e.g., to hold different data.

Storage subsystem 1004 may include removable and/or built-in devices. Storage subsystem 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1004 may include volatile, nonvolatile, dynamic, static, read/write, read-only, random-access, sequential-access, location-addressable, file-addressable, and/or content-addressable devices.

It will be appreciated that storage subsystem 1004 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1002 and storage subsystem 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1006 may be used to present a visual representation of data held by storage subsystem 1004. This visual representation may take the form of a graphical user interface (GUI). As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology. Such display devices may be combined with logic subsystem 1002 and/or storage subsystem 1004 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

Another example provides a near-eye display system, comprising an eye-imaging camera, comprising an image sensor, and an array of lenses, each lens of the array of lenses configured to focus an image of an eye onto a different area of the image sensor than each other lens of the array of lenses. The eye-imaging camera may additionally or alternatively include an iris recognition camera. Each lens of the array of lenses may additionally or alternatively be configured to provide a different depth of field range. Each lens of the array of lenses may additionally or alternatively include a metamaterial lens. The array of lenses may additionally or alternatively be configured to offset an FOV of the image sensor from a direction normal to a plane of the image sensor. The near-eye display system may additionally or alternatively include a controller configured to receive a frame of image data from the image sensor, the frame of image data comprising the images focused onto the different areas of image sensor by the lenses of the array of lenses, and to combine the images into a combined image via a super-resolution algorithm. The near-eye display system may additionally or alternatively include a controller configured to receive a frame of image data from the image sensor, the frame of image data comprising the images focused onto the different areas of image sensor by the lenses of the array of lenses, and to process the images separately. The near-eye display system may additionally or alternatively include a controller configured to receive a frame of image data from the image sensor, the frame of image data comprising the images focused onto the different areas of image sensor by the lenses of the array of lenses, and to determine depth information from the images. The near-eye display system may additionally or alternatively include a controller configured to receive a frame of image data from the image sensor, the frame of image data comprising the images focused onto the different areas of image sensor by the lenses of the array of lenses, and to determine a gaze direction of the eye from the frame of image data via a trained machine learning function.

Another example provides a method enacted on a near-eye system, the method comprising emitting light from a light source toward an eye, and focusing light reflected from the eye onto an image sensor via an array of lenses such that each lens of the array of lenses focuses an image of at least a portion of the eye onto a different area of the image sensor than each other lens of the array of lenses. The images focused by the lenses of the array of lenses onto the image sensor may additionally or alternatively include substantially similar fields of view. The method may additionally or alternatively include receiving, at a controller of the near-eye display system, a frame of image data comprising the images focused onto the different areas of the image sensor, and using a trained machine learning function to determine a gaze direction from the frame of image data. The method may additionally or alternatively include receiving, at a controller of the near-eye display system, a frame of image data comprising the images focused onto the different areas of the image sensor, and separately processing the images. The method may additionally or alternatively include determining depth information from the images focused onto the different areas of the image sensor.

Another example provides a near-eye system, comprising an eye-imaging camera comprising a light source configured to emit light toward an eye, an image sensor, and an array of metamaterial lenses, each metamaterial lens configured to focus an image of an eye onto a different area of the image sensor than each other metamaterial lens. The array of metamaterial lenses may additionally or alternatively be configured to offset an FOV of the image sensor from a direction normal to a plane of the image sensor. The near-eye system may additionally or alternatively include a controller configured to receive a frame of image data from the image sensor, the frame of image data comprising the images focused onto the different areas of the image sensor by the array of metamaterial lenses. The controller may additionally or alternatively be configured to combine the images into a combined image. The controller may additionally or alternatively be configured to separately process the images. The controller may additionally or alternatively be configured to determine a gaze direction of the eye from the frame of image data via a trained machine learning function.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A near-eye display system, comprising:
an eye-imaging camera, comprising
an image sensor, and
an array of lenses, each lens of the array of lenses configured to focus an image of an eye onto a different area of the image sensor than each other lens of the array of lenses.

2. The near-eye display system of claim 1, wherein the eye-imaging camera comprises an iris recognition camera.

3. The near-eye display system of claim 1, wherein each lens of the array of lenses is configured to provide a different depth of field range.

4. The near-eye display system of claim 1, wherein each lens of the array of lenses comprises a metamaterial lens.

5. The near-eye display system of claim 4, wherein the array of lenses is configured to offset an FOV of the image sensor from a direction normal to a plane of the image sensor.

6. The near-eye display system of claim 1, further comprising a controller configured to receive a frame of image data from the image sensor, the frame of image data comprising the images focused onto the different areas of image sensor by the lenses of the array of lenses, and to combine the images into a combined image via a super-resolution algorithm.

7. The near-eye display system of claim 1, further comprising a controller configured to receive a frame of image data from the image sensor, the frame of image data comprising the images focused onto the different areas of image sensor by the lenses of the array of lenses, and to process the images separately.

8. The near-eye display system of claim 1, further comprising a controller configured to receive a frame of image data from the image sensor, the frame of image data comprising the images focused onto the different areas of image sensor by the lenses of the array of lenses, and to determine depth information from the images.

9. The near-eye display system of claim 1, further comprising a controller configured to receive a frame of image data from the image sensor, the frame of image data comprising the images focused onto the different areas of image sensor by the lenses of the array of lenses, and to determine a gaze direction of the eye from the frame of image data via a trained machine learning function.

10. A method enacted on a near-eye system, the method comprising:
emitting light from a light source toward an eye; and
focusing light reflected from the eye onto an image sensor via an array of lenses such that each lens of the array of lenses focuses an image of at least a portion of the eye onto a different area of the image sensor than each other lens of the array of lenses.

11. The method of claim 10, wherein the images focused by the lenses of the array of lenses onto the image sensor have substantially similar fields of view.

12. The method of claim 10, further comprising receiving, at a controller of the near-eye display system, a frame of image data comprising the images focused onto the different areas of the image sensor, and using a trained machine learning function to determine a gaze direction from the frame of image data.

13. The method of claim 10, further comprising receiving, at a controller of the near-eye display system, a frame of image data comprising the images focused onto the different areas of the image sensor, and separately processing the images.

14. The method of claim 10, further comprising determining depth information from the images focused onto the different areas of the image sensor.

15. A near-eye system, comprising:
an eye-imaging camera comprising
a light source configured to emit light toward an eye,
an image sensor, and
an array of metamaterial lenses, each metamaterial lens configured to focus an image of an eye onto a different area of the image sensor than each other metamaterial lens.

16. The near-eye system of claim 15, wherein the array of metamaterial lenses is configured to offset an FOV of the image sensor from a direction normal to a plane of the image sensor.

17. The near-eye system of claim 15, further comprising a controller configured to receive a frame of image data from the image sensor, the frame of image data comprising the images focused onto the different areas of the image sensor by the array of metamaterial lenses.

18. The near-eye system of claim 17, wherein the controller is configured to combine the images into a combined image.

19. The near-eye system of claim 17, wherein the controller is configured to separately process the images.

20. The near-eye system of claim 17, wherein the controller is configured to determine a gaze direction of the eye from the frame of image data via a trained machine learning function.
